(19) United States
(12) Patent Application Publication
(10) Pub. No.: US 2004/0128574 A1
(43) Pub. Date: Jul. 1, 2004

(54) Reducing integrated circuit power consumption

(76) Inventors: Franco Ricci, Chandler, AZ (US); Shay P. Demmons, Chandler, AZ (US); Lawrence T. Clark, Phoenix, AZ (US); Timothy S. Beatty, Mesa, AZ (US); Michael Wilkerson, Mesa, AZ (US); Byungwoo Choi, Chandler, AZ (US)

Correspondence Address: TROP, PRUNER & HU, P.C., Suite 100, 8554 Katy Freeway, Houston, TX, 77024, US

(21) Appl. No.: 10/335,960

(22) Filed: Dec. 31, 2002

(51) Int. Cl. G06F 1/32

(52) U.S. Cl. 713/320

(57) ABSTRACT

Techniques and apparatuses for reducing power consumption in processor based systems during active and standby modes. A low power TLB is disclosed that does not precharge invalid entries or write to output circuits physical addresses that are the same as immediately preceding lookups. A circuit to acknowledge that the integrated circuits of the processor have entered low power standby mode that is low leakage and consumes little power is disclosed. Minimum delay buffers that have very low leakage because of series placement of a long delay enable transistor with the transistors of the inverters that make up the buffers is also disclosed.

### BACKGROUND

This invention relates generally to reducing power consumption in processor based systems during active and standby modes and more particularly to low power circuits for standby and active modes and low power mode detect for standby mode.

With increasing miniaturization of portable devices such as wireless phones, personal digital assistants (PDAs), handheld computers, sub-notebook computers, and laptop computers that incorporate processors with highly dense 100 million or more transistor integrated circuits, the requirement of reduced power consumption is critical. Integrated circuits in these devices must be designed so that they not only reduce power consumption when the device is in active operation mode but also when the device is in standby mode. Standby mode in most portable devices conserves power while still retaining the state of the device for immediate access by a user.

During active modes of operation, because of the large numbers of transistors present in modern day processors and reduced power availability, integrated circuits such as Translation Lookaside Buffers (TLBs) that consume large amounts of power cannot be used. Thus, there is a continuing need for highly efficient TLB designs in portable devices that consume less power.

Similarly, because of the high density of transistors and reduced availability of power in modern day portable devices, leakage currents in the transistors of the integrated circuits in standby mode increasingly account for a significant portion of total power consumption. Existing techniques to determine that an integrated circuit has gone into standby mode also contribute to the overall power consumption of the device. Thus, there is a continuing need to create low leakage integrated circuits for standby mode and improved techniques and circuits that require less power to detect if the integrated circuit has gone into standby mode.

### BRIEF DESCRIPTION OF THE DRAWINGS

FIG. 1 is a block diagram of a wireless communication system in accordance with an embodiment of the invention;

FIG. 2 is a schematic depiction of a TLB entry that avoids discharge of invalid entries consistent with an embodiment of the invention;

FIG. 3 is a schematic depiction of a mechanism to avoid TLB lookups of the same entry on a repeated hit according to an embodiment of the invention;

FIG. 4 is a schematic depiction of a latch cell with a low power detect circuit according to an embodiment of the invention;

FIG. 5 shows signal values for operation of the low power detect circuit of FIG. 4 according to an embodiment of the invention;

FIG. 6 is a schematic depiction of a domino cell with low power detect circuit and conditional keeper according to an embodiment of the invention;

FIG. 7 is a schematic depiction of a latch cell with low leakage minimum delay buffers according to an embodiment of the invention; and

FIG. 8 is a schematic depiction of a latch cell with low leakage thick gate minimum delay buffers according to an embodiment of the invention.

### DETAILED DESCRIPTION

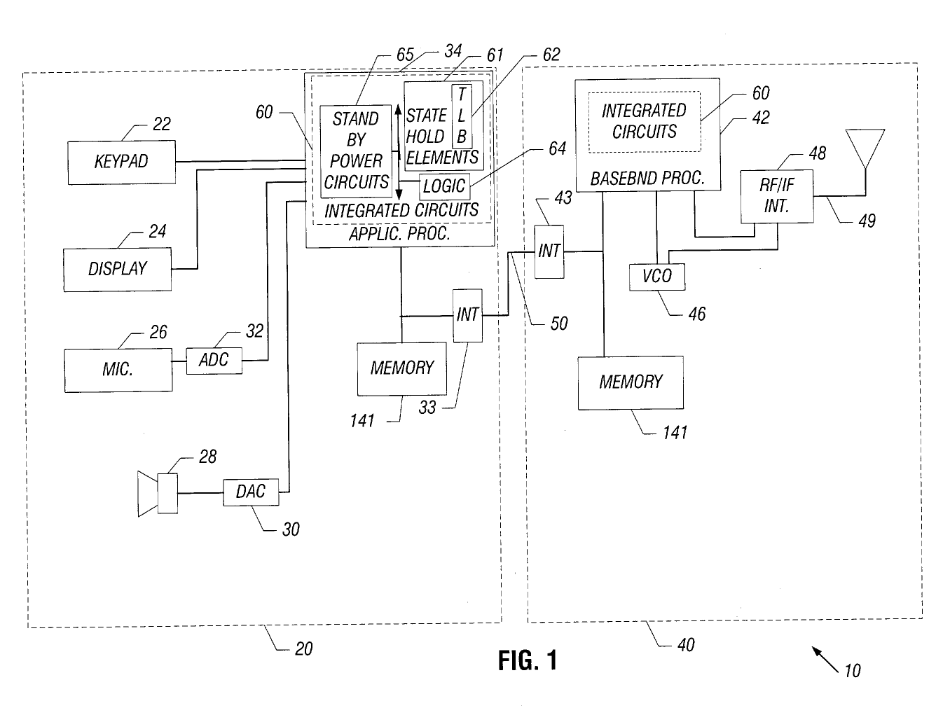

Referring to FIG. 1, some embodiments 10 of a computing or communication device that may be portable (called a “portable device 10” herein) includes an application subsystem 20 and a communication subsystem 40 that communicate via a communication link 50 of the device 10. As a more specific example, the portable device 10 may be a one-way pager, a two-way pager, a personal communication system (PCS), a personal digital assistant (PDA), a cellular telephone, a portable computer, etc. The application subsystem 20 provides features and capabilities that are visible and/or used by a user of the portable device 10. For example, the application subsystem 20 may be used for purposes of email, calendaring, audio, video, gaming, etc. The communication subsystem 40 may be used for purposes of providing wireless and/or wired communication with other networks, such as cellular networks, wireless local area networks, etc.

For the case in which the portable device 10 is a cellular telephone, the application subsystem 20 may provide an interface to the user of the cellular telephone and thus, provide a keypad 22 which the user may use to enter instructions and telephone numbers into the cellular telephone; a display 24 for displaying command options, caller information, telephone numbers, etc.; and a microphone 26 for sensing commands and/or voice data from the user. The microphone 26 thus, may provide an analog signal indicative of a voice signal, and this analog signal may be converted into a digital format by an analog-to-digital converter (ADC) 32. The digital data from the ADC 32, in turn, is provided to an application processor 34 of the application subsystem 20. Likewise, data from the keypad 22 may also be provided to the application processor 34. Graphical data may be provided by the application processor 34 to the display 24 for viewing by the user of the cellular telephone.

The application processor may be very large scale integrated circuits 60 for processing the received data and generating output to the display 24 and speaker 28 in some embodiments. The integrated circuits may include standby mode power circuits 65, state holding elements 61, and control logic 64. The standby mode power circuits 65 may include low leakage minimum delay buffers (not shown) and integrated circuits to detect when the application processor is in standby mode (not shown). State holding elements 61 may include low power consumption TLB circuits 62 such as a Content Addressable Memory (CAM) (not shown). Once the portable device 10 enters standby mode, critical data may be stored in state holdings elements 61 that can be accessed to allow immediate reentry into active operation mode. The standby mode power circuits 65, control logic 64, and state holding elements 61 will be described in greater detail below.

Among the other features of the application subsystem 20 in some embodiments, the subsystem 20 may include a speaker 28 that receives an analog signal from a digital-to-analog converter (DAC) 30 that, in turn, receives digital data from the application processor 34. For example, the speaker 28 may be used to provide an audible ringing signal to the user, for the case in which the device 10 is a cellular telephone, as well as provide an audio stream for audio data that is provided by a cellular network, for example.

The application subsystem 20 may also include a memory 141. As an example, this memory 141 may be a dynamic random access memory (DRAM) or a flash memory, as just a few examples. The memory 141 is coupled to the application processor 34 for purposes of storing data, operating system code, application code, etc. that is executed by the application processor 34. As a more specific example, in some embodiments of the invention, the memory 141 may store boot instruction code that is executed by the application processor 34 for power-on-self-test purposes. The application subsystem 20 may also include an interface 33 for purposes of establishing a communication bridge between the communication link 50 and circuitry of the application subsystem 20.

In some embodiments of the invention, the portable device 10 may include multiple communication subsystems, and in some embodiments of the invention, the portable device 10 may include multiple nodes that are coupled to the communication link 50.

In some embodiments of the invention, the communication subsystem 40 includes a baseband processor 42 that establishes the particular communication standard for the device 10. For example, if the device 10 is a cellular telephone, the baseband processor 42 may establish a code division multiple access (CDMA) cellular radiotelephone communication system, or a wide-band CDMA (W-CDMA) radiotelephone communication system, as just a few examples.

The baseband processor 42 is coupled to a radio frequency/intermediate frequency (RF/IF) interface 48 that forms an analog interface for communicating with an antenna 49 of the device 10. A voltage controlled oscillator (VCO) 46 is coupled to the RF/IF interface 48 to provide signals having the appropriate frequencies for modulation and demodulation, and the baseband processor 42 controls the VCO 46 to regulate these frequencies, in some embodiments of the invention. The baseband processor may have integrated circuits 60 including standby mode power circuits (not shown), standby mode state holding elements (not shown), and low power consumption TLB circuits (not shown) similar to application processor 34.

Among the other features of the communication subsystem 40, in some embodiments of the invention, the subsystem 40 may include a memory 141 (a DRAM memory or flash memory, as a few examples) that is coupled to the baseband processor 42. The memory 141 may store program instructions and/or data.

The processor 34 or 42 may include one or more microprocessors. In some embodiments of the invention, the baseband processor 42 may be a digital signal processing (DSP) engine. Other and different processors may be used for the application 34 and baseband 42 processors.

TLBs are used in processors as fast page table caches to allow high speed translation of virtual to physical addresses through the use of page mapping. Portable device 10 including application processor 34 and baseband processor 42 executes physical addresses that may correspond to a location in memory, device identification, interrupt identification or to identify any number of other resources in the portable device. Virtual addresses are used by portable devices to allow multiple software applications to execute in their own data and address memory space. The processor executing software applications may be utilizing the same underlying memory locations and other resources for each of the software applications, but a portable device operating system (i.e., a software application that oversees and allocates resources to all other software applications) in cooperation with the TLB in the processor reduces conflicts between the software applications. Each software application is assigned a virtual address space by the operating system. The software application uses virtual addresses that include identification information to inform the operating system and TLB that the virtual address is associated with that software application. The TLB includes a Content Addressable Memory (CAM) which contains virtual address to physical address mappings. Thus, for a generated virtual address, the TLB performs a lookup of the CAM to determine the corresponding physical address. Because of limited area in the processor, TLB CAMs are generally a small number of entries and may be 32, 64, 128, or 256 entries. Thus, not all virtual address to physical address mappings can be stored in the TLB for all software applications executing on the processor. If a virtual address is present, the TLB retrieves the physical address and sends it to the processor. If the virtual address is not present, the TLB must load the virtual address to physical address mapping into the CAM. When the CAM is full, this requires invalidating one of the virtual address to physical address entries in the CAM. Generally, the CAM entry which is invalidated is the entry which has not been accessed for a long period of time.

TLB circuits in processors dissipate large amounts of power because of the many transitions of signals needed to perform lookups of the CAM and to replace invalid entries when the CAM is full. A CAM lookup matches the incoming virtual address to that stored in the CAM by an entry by entry match using a large precharged OR logic gate. Non-matching locations discharge this large fanin logic gate. After the correct virtual address to physical address entry is found in the CAM, the CAM match line identification value is latched and becomes the ENABLE for the following register file that contains the physical address corresponding to the virtual address of that entry. Spatial and temporal locality is a phenomenon in which a particular address or group of addresses is repeatedly accessed by the software application executing on the processor. Not precharging invalid entries in the CAM and taking advantage of the phenomenon of spatial and temporal locality are two ways to reduce the amount of power consumed by the TLB.

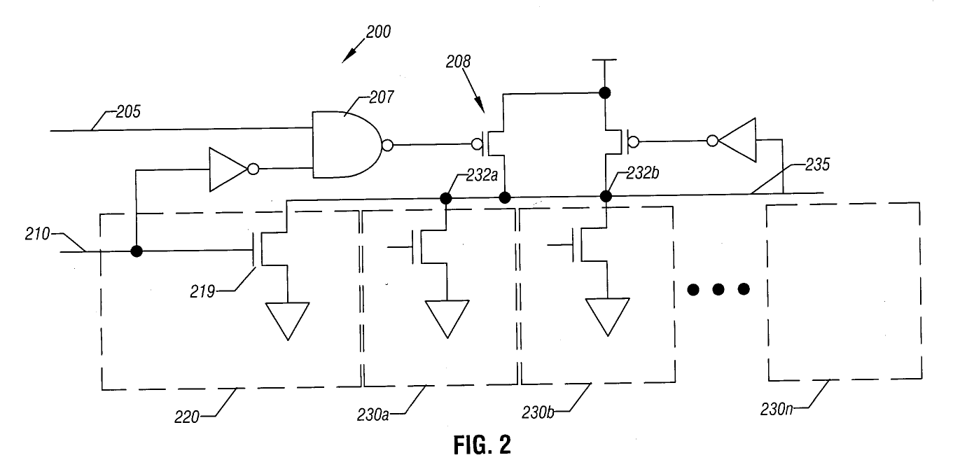

Referring to FIG. 2, a schematic circuit depiction 200 of a TLB entry that avoids precharge and discharge of invalid entries consistent with some embodiments of the invention is shown. As described above, entries in the TLB CAM may be invalid because they have not been accessed for a long period of time or have never been loaded with valid data. As shown in FIG. 2, if the TLB entry is invalid, the INVALID line 210 is set, with the transistor 219 in the valid bit cell 220 turning on to set low/ground MATCH output line 235 to indicate that this TLB entry does not contain a match for the virtual address. Address CAM cells 230a, 230b to 230n may not be allowed to precharge since the nodes 232a, 232b to 232n are set low/grounded preventing any voltage across the transistors in the address CAM cells in some embodiments. During a TLB CAM lookup, an entry by entry match is performed in the CAM by enabling the PRECHARGE line 205. NAND gate 207, for an invalid TLB entry receives as its inputs, in one embodiment, Inverted[INVALID]=0 and PRECHARGE=1. The output of the NAND gate corresponds to a logic high that turns off the P-channel transistor 208, thus permitting the nodes 232a, 232b to 232n to be set low/grounded. Precharge and discharge of the address CAM cells 230a, 230b, to 230n may not be performed for an invalid TLB entry, thus permitting significant power savings. While some embodiments of the invention have been described with reference to a TLB including a CAM which avoids precharge and discharge of invalid entries, those skilled in the art will appreciate numerous modifications and variations therefrom. For example, the techniques and apparatus described for this embodiment of the invention are applicable to any lookup mechanism in write buffers, caches, etc.

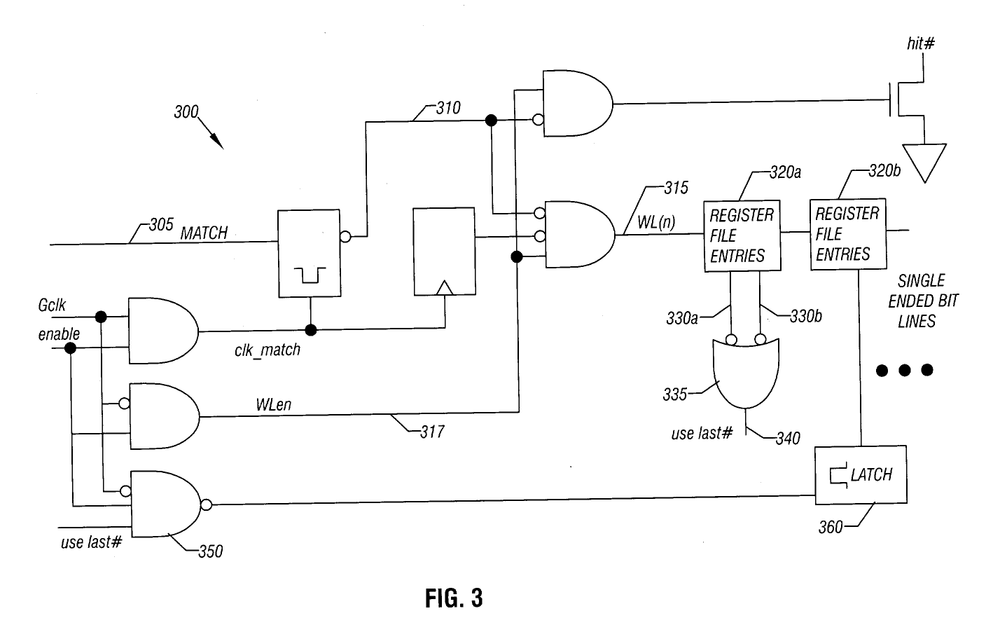

Referring now to FIG. 3, a schematic circuit depiction of a mechanism to avoid TLB lookups of the same entry on a repeated hit according to some embodiments of the invention is shown. As described above, repeated hits to the same TLB entries occur because of the phenomenon of spatial and temporal locality. The circuit depiction 300 shown in FIG. 3 includes a MATCH input line 305. The last TLB CAM entry matched is held at word line WL 315 (shown in FIG. 3 for single bit of the word line denoted as WL(n)). A word line 315 is enabled by the WLen signal when the CAM entry to be driven out of the TLB CAM is different from the immediately preceding TLB CAM entry. Thus, if the entry presently driven out of the TLB CAM is the correct one, the register file entries 320a, 320b, to 320n (not shown) are not read and the physical address output of the TLB is left in the present state. This reduces the power consumed by the TLB for register file reads to the same TLB CAM entry as the immediate preceding read.

Another aspect of some embodiments allow detection and reporting of hits to the same TLB CAM entries without the need for any additional logic. As shown in FIG. 3, one column of the register file entries 320a is differentially read via differential bit lines 330a and 330b. The differential bit lines feed into Exclusive Or (XOR) logic gate 335 that allows determination of whether any word line WL fired. If a word line WL fired, logic signal line USELAST# 340 is set to logic low, indicating not to use the last physical address generated by the TLB. USELAST# is fed back into NAND logic gate 350. When USELAST# is set to logic low indicating that a new physical address is generated by the TLB, the output of NAND logic gate 350 is set to logic high, thus latching 360 a new value on the output of the TLB.

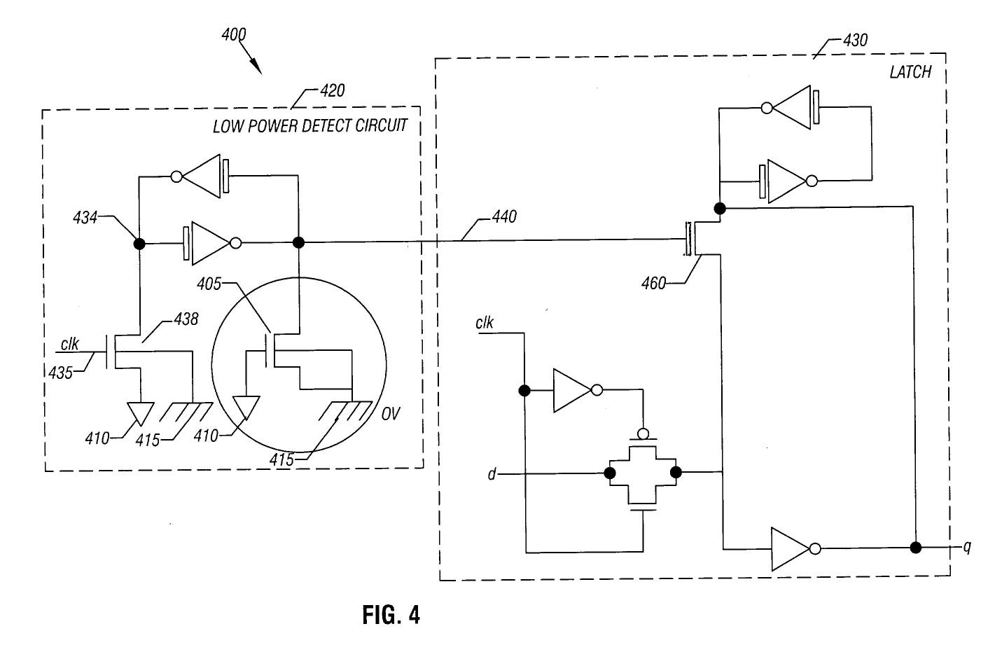

In FIG. 4, an aspect of some embodiments to reduce the consumption of power by integrated circuits 60 is shown as circuit 400, which can detect entry of the integrated circuit into a low power mode. Integrated circuits of portable device 10 enter standby mode either by the user telling the device to go into standby mode or because the device has not been utilized for a period of time, causing it to automatically power down into standby mode. The integrated circuits enter low power standby mode passively, that is the free floating ground voltage Vssl shown in FIG. 4 by the triangle symbol 410 rises through leakage so as not to expend extra power to enter the standby mode. Thus, a key problem is detecting that an integrated circuit has actually entered standby mode since the time to enter and leave standby mode varies by orders of magnitude depending on the fabrication process used and the operating temperature of the integrated circuit.

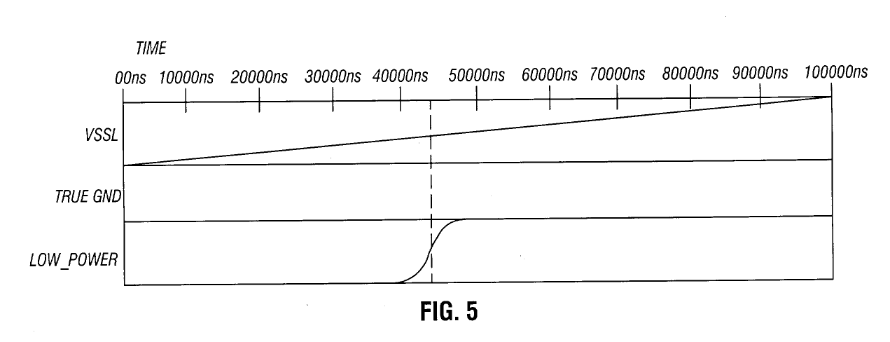

FIG. 4 shows a schematic circuit depiction 400 of a latch cell 430 with a low power detect circuit 420 according to some embodiments of the invention. FIG. 5 shows signal values for operation of the low power detect circuit of FIG. 4 in accordance with some embodiments of the invention. The low power detect circuit line 440 Inverted[LOW_POWER] is enabled (set to logic low) when the system enters low power mode and disabled (set to logic high) in normal active mode of operation. When the portable device 10 is in normal active mode of operation, the CLK signal 435 continuously disables the Inverted[LOW_POWER] line 440. CLK signal 435 turns transistor 438 on driving node 439 to a logic low and setting to logic high Inverted [LOW_POWER] line 440, thus indicating that the system is in normal active mode of operation. When portable device 10 enters into standby mode, circuitry collapses the power supplies by allowing the free floating ground voltage Vssl shown in FIG. 4 by the triangle symbol 410 to rise a limited amount over time as shown in FIG. 5. Because the body and source of the N-channel device 405 are at true ground (0 V) 415 the increase in voltage in Vssl, which is on the gate of N-channel device, turns on the N-channel device thus enabling (set to logic low) Inverted[LOW_POWER] line 440. This is shown in FIG. 5 with the LOW_POWER signal line 440 transitioning to logic high at approximately 42000 nanoseconds, in one embodiment, when Vssl reaches the appropriate value to turn on the N-channel device 405. Latch 430 saves the current state of the latch when it detects entry into the low power standby mode by turning off the thick gate oxide pass device 460 when Inverted[LOW_POWER] line 440 is enabled (set to logic low).

In some embodiments of the invention, latch 430 is always supplied power via the full supply rails, i.e., between Vcc and true ground (0V) 415. It is therefore ideally comprised of transistors that have a higher threshold voltage Vt than the rest of circuit 400 that operates at a lower power state. This allows the circuit comprising latch 430 to contribute a relatively low leakage current. In some embodiments of the invention, circuits fed by the output of circuit 400 can propagate the LOW_POWER signal indicating that a low power state has been entered while not contributing to the consumption of standby power.

In some embodiments of the invention, various combinations of low and high threshold voltage transistors as well as oxide thicknesses are possible to aid in tuning the low power detect circuit. Since thick-gate transistors may have a higher threshold voltage and thus lower drain to source leakage and lower gate leakage, some embodiments of the invention may utilize these transistors for both latch circuit 430 and other ancillary circuits that propagate the LOW_POWER signal throughout the integrated circuit.

Since the likelihood of a transistor failure in low power mode is based on the P to N strength ratio of latch 430, and the highest strength ratios may be found in domino circuits or other pre-charged circuits, it is advantageous to provide a strong conditional keeper circuit (not shown in FIG. 4) during low power mode. A conditional keeper circuit prevents a bit stored in a memory cell or latch from losing its charge. In some embodiments of the invention, the conditional keeper circuit may only be active during low power state, thus requiring the LOW_POWER signal 440 to enable the conditional keeper.

Low power detection circuit 420 relies on the strength ratio between the holding state of a P-channel device (not shown) and N-channel transistor 405 that is gradually turned on as the supply Vssl is raised. Strength ratios may be prone to substantial differences based on manufacturing variations between the transistors. Thus, in some embodiments of the invention, to reduce this variation, the strength of the N-channel transistor may be programmable by adding series devices programmed using flash or fuse cells when the circuit 420 is tested.

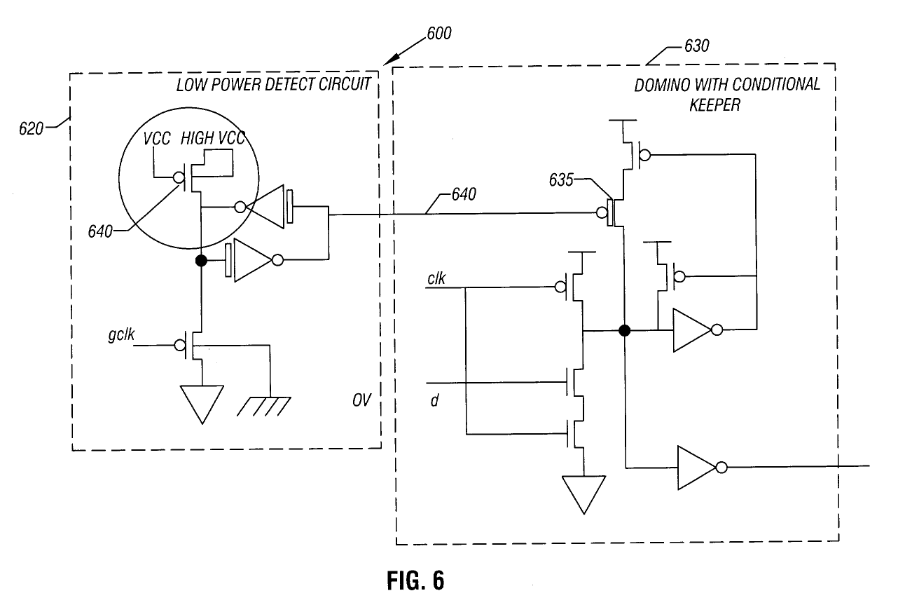

FIG. 6, in accordance with some embodiments of the invention, is a schematic circuit depiction 800 of a low power detect circuit 620 with a domino cell and conditional keeper 630. Other embodiments of the low power detect circuit as shown in FIG. 6 may use the implementation 620 that uses a P-channel transistor device that is fully complementary to the N-channel device 405 shown in low power detect circuit 420 of FIG. 4. The domino cell and conditional keeper 630 coupled to the low power detect circuit 620 receives LOW_POWER signal line 640 at P-channel thick gate device 635. The domino cell allows a single clock to precharge and evaluate the conditional keeper circuit. The LOW_POWER signal triggers the P-channel isolation device 635 that enables the conditional keeper circuit. In some embodiments the conditional keeper device 635 may include a thick gate as described above.

In some embodiments of the invention, domino cell and conditional keeper circuit 630 as shown in FIG. 6 can be functionally tested during the high-temperature burn-in cycle used to test the integrated circuits of processors 34 and 42. Present implementations of domino logic cells may stop functioning during burn-in functional testing and thus are not stressed properly. In some embodiments of the invention, to overcome this problem, the conditional keeper circuit can operate during burn-in functional testing and then be deactivated during normal operation. In other embodiments of the invention as shown in FIG. 6, the domino cell and conditional keeper circuit 630 are enabled during burn in functional testing as well as low power standby mode by local detection of standby mode via LOW_POWER signal line 640. Separate circuitry (not shown) may also be used to combine the burn-in and low-power conditions.

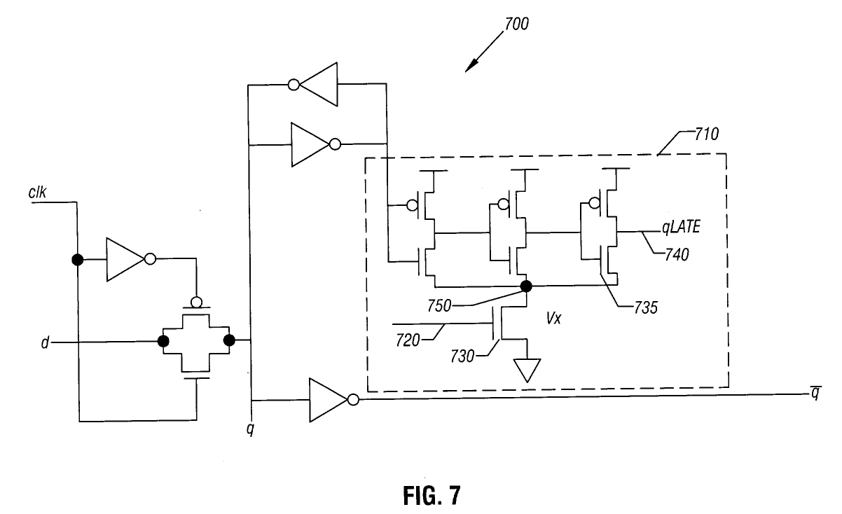

Referring now to FIG. 7, a schematic circuit depiction of a latch cell with low leakage minimum delay buffers 700 according to some embodiments of the invention is shown. Minimum delay buffers are used in integrated circuits to provide propagation time delays for signals going from the circuit input to the circuit output. Thus, minimum delay buffers provide protection against an integrated circuit being too fast so as to cause failures such as race conditions. A race condition is a situation in which two or more signals change at the same time, and the order in which they change are perceived to effect the operation of the integrated circuit. Minimum delay buffers are also needed to test integrated circuits because of the use of scan for test techniques incorporating pulse latches for clock signals that may need delay.

Minimum delays in integrated circuits may be implemented by additional elements that are added into the integrated circuit so that the circuit functions properly. However, such elements are prone to current leakage that may account for large amounts of the total power consumed by the processor. Increasingly, as integrated circuits in processors become more and more dense, the feature size of each transistor decreases significantly. Reduced feature sizes require the use of extremely thin semiconductor oxide layers during fabrication of the integrated circuits of the processor. Such extremely thin oxide layers allow much higher leakage through the terminals of each transistor. As the active power consumption of processors becomes smaller and smaller because of the reduced voltages such processors operate on, power consumption caused from current leakage accounts for a large amount of the total power consumed by the processor. Thus, there exists a continuing need for insertion of minimum delays into integrated circuits that do not aggravate the current leakage and power consumption problem.

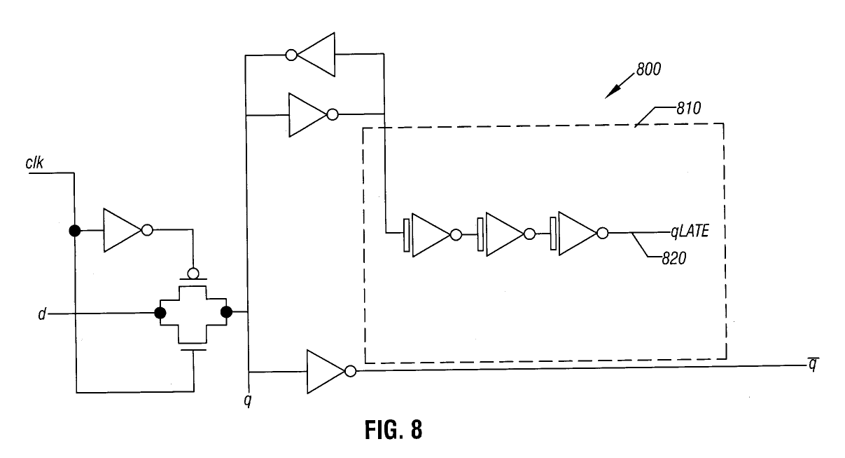

FIG. 7 and FIG. 8 show two embodiments of latch cells that include low leakage minimum delay buffers. In FIG. 7, the minimum delay buffers 710 include input signal line LONG_DELAY_ENABLE 720 and output signal line QLATE 740. The LONG_DELAY_ENABLE signal 720 turns on and off N-channel transistor 730. Minimum delay buffers that have at least two transistors in series (e.g. transistor 730 and 735) from LONG_DELAY_ENABLE 720 to QLATE 740 as shown in 710 have negligible leakage due to the body effect voltage Vx. In some embodiments of the invention, the channel region of transistor 730 may be fabricated with a length longer than minimum channel to increase the body effect and lessen leakage since longer channel transistors have inherently less leakage than an equivalent transistor with a short channel.

The operation of the body effect voltage Vx to reduce leakage with reference to the two series transistors 730 and 735 is now described in more detail. Both transistors 730 and 735 have minimal amounts of leakage current flowing through them. Because they are in series, both transistors 730 and 735 have equal current flowing through them, thus making the voltage Vx between the transistors not at zero volts, but at some small voltage (the voltage is caused by the finite resistance of the transistors that the leakage current travels through). Thus, transistor 735 is exposed to a negative gate to source leakage voltage that makes that transistor leak less. The bottom transistor 730 has a reduced drain to source leakage voltage that makes it leak less. The two combined transistors in series leaks less than single transistor minimum delay buffers without long delay enable transistor 730.

Low leakage minimum delay buffers 710 shown in FIG. 7 can be disabled by setting LONG_DELAY _ENABLE signal 720 to logic low. This eliminates almost all current flow including most leakage current flow through the transistors of the minimum delay buffers. The latch cell and minimum delay buffers 700 may be used as part of dedicated scan chains to perform Built-In-Self-Test (BIST), with output signal line QLATE 740 being exclusively used to connect scan chains. When the integrated circuits of the processor are not in test mode, the minimum delay buffers 710 can be disabled to permit normal operation of the latch cell.

Referring to FIG. 8, another embodiment of a latch cell with low leakage minimum delay buffer 810 is shown. In some embodiments of the invention, low leakage minimum delay buffer 810 may be implemented with inverters of thicker gate oxide than standard transistors, thus reducing leakage through the gate terminal of the transistor significantly. Thicker oxides used in the thick gate oxide transistors of the inverters of low leakage minimum delay buffer 810 also have higher threshold voltages Vt that result in reduced drain to source leakage. This embodiment may have the advantage of saving power without requiring a LONG_DELAY_ENABLE signal.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a virtual address at a plurality of state holding elements that hold a corresponding physical address value;
determining one or more physical address values to which the virtual address matches; and
enabling return of the one or more physical address values without precharging the state holding elements of the plurality of state holding elements that hold invalid physical address values.

2. The method of claim 1, comprising:
caching a plurality of virtual to physical address mappings in a translation lookaside buffer in the state holding elements, said translation lookaside buffer having a plurality of entries for the virtual to physical address mappings.

3. The method of claim 2, wherein determining physical address value matches further comprises:
searching the translation lookaside buffer for one or more valid entries of the plurality of entries that contain the one or more physical address values.

4. The method of claim 2, comprising:
determining whether a subsequent lookup request to the translation lookaside buffer is to an entry different than the one or more valid entries of the plurality of entries to detect repeated hits to the same entry.

5. The method of claim 4, comprising:
providing a writeline driver for a corresponding cache line for the plurality of entries; and
holding the last entry of the plurality of entries that match locally at the writeline driver.

6. The method of claim 5, comprising:
enabling the writeline driver only when the entry is different than the one or more valid entries.

7. The method of claim 6, comprising:
providing an n-bit wide output per physical address value; and
reading together at least two bits of the per physical address value for the writeline driver of the plurality of entries of the translation lookaside buffer.

8. An apparatus comprising:
a plurality of state holding elements that receive a virtual address, wherein said state holdings elements hold a corresponding physical address value;
comparison logic to determine one or more physical address values to which the virtual address matches; and
output logic to enable return of the one or more physical address values while avoiding precharging the state holding elements of the plurality of state holding elements that hold invalid physical address values.

9. The apparatus of claim 8, wherein said state holding elements includes a translation lookaside buffer to cache a plurality of virtual to physical address mappings, said translation lookaside buffer having a plurality of entries for the virtual to physical address mappings.

10. The apparatus of claim 9, wherein the comparison logic searches the translation lookaside buffer for one or more valid entries of the plurality of entries that contain the one or more physical address values.

11. The apparatus of claim 9, wherein the output logic determines whether a subsequent lookup request to the translation lookaside buffer is to an entry different than the one or more valid entries of the plurality of entries to detect repeated hits to the same entry.

12. The apparatus of claim 11, comprising:
a writeline driver for a corresponding cache line for the plurality of entries, wherein said writeline driver holds the last entry of the plurality of entries that match locally.

13. The apparatus of claim 12, wherein said writeline driver is enabled only when the entry is different than the one or more valid entries.

14. The apparatus of claim 13, comprising:
an n-bit wide output per physical address value, wherein at least two bits of the per physical address value are read together for the writeline driver of the plurality of entries of the translation lookaside buffer.

15. A table lookup apparatus comprising:
an input transistor having a gate, a source, a drain and a substrate, said gate coupled to receive a control signal, said source coupled to receive a logic low voltage for an integrated circuit coupled to said drain;
circuitry coupled to said input transistor to selectively apply to the gate a voltage more than the logic low voltage based on the control signal, wherein said voltage sets the drain to a logic low voltage; and
a first pair of series connected N-channel transistors including a corresponding drain and a corresponding source, each of said first pair of N-channel transistors having the corresponding drain coupled to the drain of said input transistor, wherein said logic low voltage on the drain does not permit the series connected N-channel transistors to precharge.

16. The table lookup apparatus of claim 15, wherein said drain couples to an output signal line that indicates a lookup match.

17. A method comprising:
placing a plurality of integrated circuits in a lower power consuming mode;
transitioning a semiconductor switch device into a conducting state to enable a lower power consuming mode signal; and
verifying at intervals that the plurality of integrated circuits is in lower power consuming mode.

18. The method of claim 17, wherein placing the plurality of integrated circuits further comprises passively placing the integrated circuits into low power mode.

19. The method of claim 17, wherein transitioning the semiconductor switch device includes allowing a first voltage at a terminal of the device to reach an appropriate level to make the device conducting.

20. An apparatus comprising:
control logic to place a plurality of integrated circuits into low power mode;
a semiconductor switch device capable of transition into a conducting state to enable a low power mode signal; and
pulse logic that periodically verifies that the plurality of integrated circuits is in low power mode.

21. The apparatus of claim 20, wherein the control logic passively places the integrated circuits into low power mode.

22. The apparatus of claim 20, wherein the integrated circuits in low power mode permit a first voltage at a terminal of the semiconductor switch device to reach an appropriate level to make the device conducting.

23. An apparatus comprising:
a low power mode detect circuit adapted to detect a rising first voltage signal;
a latch circuit;
a coupling circuit, wherein said coupling circuit connects the low power mode detect circuit to the latch circuit.

24. The apparatus of claim 23, wherein the low power mode detect circuit further comprises cross coupled inverters.

25. The apparatus of claim 24, wherein low power mode detect circuit further comprises a clock enabled transistor that can sensitize the low power mode detect circuit.

26. The apparatus of claim 25, wherein the low power mode detect circuit further comprises a transistor having its drain coupled to a node of the cross coupled inverters, wherein the gate of the transistor is coupled to a power supply capable of movement to enter a low-power mode, wherein said source of the transistor is coupled to ground.

27. A method comprising:
placing at least two semiconductor switch devices in series between a first input and a first output signal line; and
setting one of the semiconductor switch devices into a conducting state, wherein said semiconductor switch devices collectively reduce leakage current flowing through each of the devices.

28. The method of claim 27, wherein said semiconductor switch devices are N-channel transistors.

29. The method of claim 27, wherein said at least two semiconductor switch devices are adapted to provide a minimum delay for inputs at a second input signal line coupled to the devices.

30. An apparatus comprising:
at least two semiconductor switch devices in series between a first input and a first output signal line; and
enabling logic to set one of the semiconductor switch devices into a conducting state, wherein said semiconductor switch devices collectively reduce leakage current flowing through each of the devices.

31. The apparatus of claim 30, wherein said semiconductor switch devices are N-channel transistors.

32. The apparatus of claim 30, wherein said at least two semiconductor switch devices are adapted to provide a minimum delay for inputs at a second input signal line coupled to the devices.

33. An apparatus comprising:
a latch circuit;
a low leakage minimum delay buffer, wherein said low leakage minimum delay buffer is enabled by a control signal;
a coupling circuit, wherein said coupling circuit connects the latch circuit to the low leakage minimum delay buffers.

34. The apparatus of claim 33, wherein said coupling circuit includes cross-coupled inverters.

35. The apparatus of claim 34, wherein said low leakage minimum delay buffer further comprises:
at least two n-channel devices in series between a node of the cross-coupled inverters and an output signal line; and
wherein said control signal turns one of the n-channel devices on, wherein said n-channel devices collectively reduce leakage current flowing through each of the devices.

36. A communication system comprising:
an application processor;
a flash memory coupled to the application processor;
a baseband processor coupled via a bus to the application processor, where the baseband processor includes,
a plurality of state holding elements that receive a virtual address, wherein said state holdings elements hold a corresponding physical address value;
comparison logic to determine one or more physical address values to which the virtual address matches;
output logic to enable return of the one or more physical address values while avoiding precharging the state holding elements of the plurality of state holding elements that hold invalid physical address values; and
wherein said state holding elements include a translation lookaside buffer to cache a plurality of virtual to physical address mappings, said translation lookaside buffer having a plurality of entries for the virtual to physical address mappings.

37. The system of claim 36, wherein the output logic determines whether a subsequent lookup request to the translation lookaside buffer is to an entry different than the one or more valid entries of the plurality of entries to detect repeated hits to the same entry.
